(19) United States
(12) Patent Application Publication
(10) Pub. No.: US 2024/0380265 A1
(43) Pub. Date: Nov. 14, 2024

(54) COOLING SYSTEM FOR LOAD POINT DEPENDENT COOLING OF A ROTOR OF AN ELECTRIC MACHINE

(71) Applicant: MAGNA Powertrain GmbH & Co KG, Lannach (AT)

(72) Inventors: Daniel Prix, Graz (AT); Wolfgang Schweiger, St. Stefan (AT); Christoph Gsenger, Graz (AT); Stefan Lienhart, Graz (AT); Michael Dienbauer, Graz (AT)

(21) Appl. No.: 18/564,764

(22) PCT Filed: Apr. 4, 2022
(86) PCT No.: PCT/EP2022/058848

§ 371 Date: Nov. 28, 2023

(30) Foreign Application Priority Data
Jun. 2, 2021 (DE) 10 2021 205 656.3

(51) Int. Cl. H02K 1/32; H02K 9/00

(52) U.S. Cl. CPC H02K 1/32; H02K 9/00

(57) ABSTRACT

The present disclosure relates to a cooling system for load point dependent cooling of a rotor of an electric machine. The cooling system includes at least one coolant path extending at least partially into a rotor of an electric machine. At least one passive valve is arranged in the coolant path which regulates the flow rate of the coolant through the coolant path.

### CROSS-REFERENCE TO RELATED APPLICATIONS

This application is a National Stage of International Application No. PCT/EP2022/058848, filed Apr. 4, 2022, which claims priority to DE 10 2021 205 656.3, filed Jun. 2, 2021. The entire disclosures of each of the above applications are incorporated herein by reference.

### FIELD

The present disclosure relates to a cooling system for load point dependent cooling of a rotor of an electric machine, wherein the cooling system includes at least one coolant path extending at least partially into a rotor of an electric machine and wherein at least one passive valve is arranged in the coolant path and controls the flow rate of coolant through the coolant path.

### BACKGROUND

This section provides information related to the present disclosure which is not necessarily prior art.

Electric machines of the type mentioned above are used to convert electrical energy into mechanical energy and vice versa and are widely used as motors and/or generators in the field of automotive engineering.

Electric machines include a stationary stator and a movable rotor, wherein the rotor in the most common design of an electric machine is rotatably mounted within an annular stator.

Electric machines generate heat during their operation due to dielectric loss, which on the one hand causes a deterioration in the efficiency of the electric machine and on the other hand negatively affects reliable operation of the electric machine over its service life. Therefore, in drive arrangements with electric machines, a cooling device is usually provided to cool the parts of the electric machine that need to be cooled.

Conventional cooling systems for electric machines use a circulating gaseous or liquid coolant. The coolant circulates, for example, in a housing of the electric machine or in a rotor shaft designed as a hollow shaft on which the rotor of the electric machine is arranged. Due to its heat capacity, the coolant absorbs heat and transports it away.

DE 10 2016 004 931 A1 describes an electric machine having a rotor shaft. The rotor shaft has an internal cavity into which a cooling lance is inserted. The interior of the hollow shaft is supplied with coolant via openings in the cooling lance, depending on the pressure in the coolant line.

DE 10 2018 121 348 A1 describes an electric motor with variable cooling of the stator rather than the rotor. Speed-dependent valves are used there that open and close the coolant flow to the stator depending on the speed.

### SUMMARY

This section provides a general summary of the disclosure, and is not a comprehensive disclosure of its full scope or all of its features.

It is an object of the present disclosure to provide an improved cooling system for a rotor of an electric machine, said cooling system being distinguished by a load point dependent cooling of the rotor.

This need can be met by the subject matter of the present disclosure and claims. Advantageous embodiments of the present disclosure are described in the present disclosure and claims.

The cooling system according to the present disclosure is used for load point dependent cooling of a rotor of an electric machine. The electric machine is designed in a manner that is generally known in the art and includes the rotor as a rotating component and a stator as a stationary component.

The cooling system has at least one coolant path extending at least partially into a rotor of an electric machine.

In accordance with the present disclosure, at least one passive valve is arranged in the coolant path and controls the flow rate of coolant through the coolant path.

Preferably, a central cavity at least partially penetrating a rotor shaft of the rotor constitutes part of the coolant path.

Further preferably, at least one transverse bore connected to the central cavity and an outer circumference of the rotor shaft constitutes another part of the coolant path.

The passive valve can be arranged in the region of the central cavity and/or in the region of the transverse bore.

The passive valve controls the flow rate of coolant through the coolant path in dependence on a temperature of the rotor, a pressure in the coolant path, and/or a speed of the rotor.

In an advantageous variant, the passive valve controls the flow rate of the coolant through the coolant path in dependence on the temperature of the rotor, wherein the passive valve has at least one SMA (“Shape Memory Alloy”) element for this purpose.

In another preferred variant, the passive valve controls the flow rate of the coolant through the coolant path as a function of the pressure in the coolant path, wherein the passive valve has for this purpose a diaphragm or a plate that is biased against the direction of flow of the coolant via an elastic element.

The pressure in the coolant path is preferably dependent on the speed of a coolant pump of the cooling system.

In another advantageous variant, the passive valve controls the flow rate of the coolant through the coolant path in dependence on a rotational speed of the rotor, wherein the passive valve has for this purpose a ball that is biased against the centrifugal force due to the rotation of the rotor via an elastic element.

It goes without saying that several passive valves can be arranged in a coolant path, which may be of the same or different design.

By means of a cooling system according to the present disclosure, a reduction of mechanical and hydraulic additional losses can be achieved by cooling a rotor of an electric machine, resulting in an optimization in the areas of efficiency and thermal availability of the electric machine.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 shows a schematic cross-sectional view of a first variant of a coolant path of a cooling system with a temperature-dependent passive valve.

FIG. 2 shows a schematic cross-sectional view of a second variant of a coolant path of a cooling system with an alternative temperature-dependent passive valve.

FIG. 3 shows an isometric view of an SMA element according to FIG. 2.

FIG. 4 shows a schematic cross-sectional view of a variant of a coolant path of a cooling system with a speed-dependent passive valve.

FIG. 5a shows a schematic cross-sectional view of a variant of a coolant path of a cooling system with a closed pressure-dependent passive valve.

FIG. 5b shows a schematic cross-sectional view of a fourth variant of a coolant path of a cooling system with an open pressure-dependent passive valve.

### DETAILED DESCRIPTION

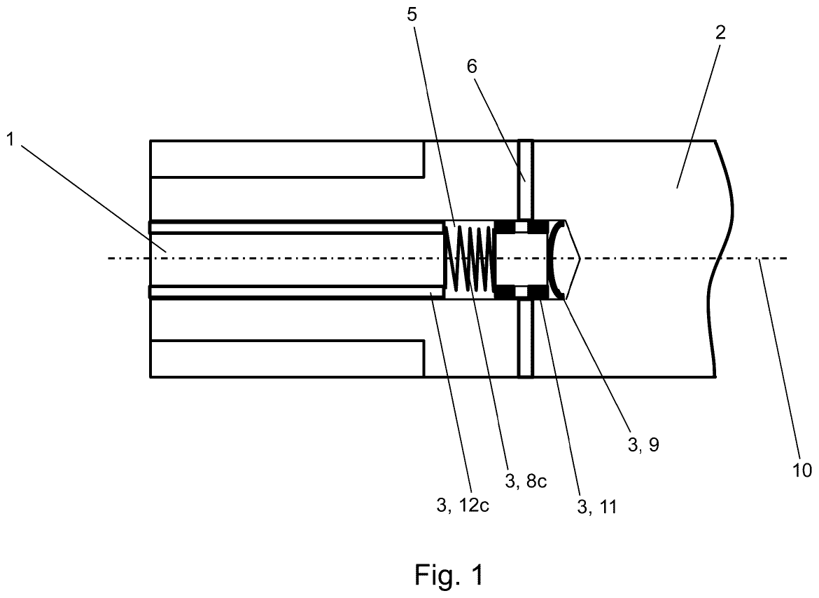

In FIG. 1 to FIG. 3, different inventive variants of a passive valve 3 in a coolant path 1 of a cooling system according to the present disclosure are shown schematically.

The cooling system is used for load point dependent cooling of a rotor 2 of an electric machine. The cooling system has a coolant sump, a coolant pump, and a coolant radiator, wherein the coolant pump pumps coolant from the coolant sump via the coolant radiator into different coolant paths, including into the coolant path 1 for cooling the rotor 2. The coolant pump is driven here electrically or mechanically. The coolant in the present exemplary embodiment is oil. Further coolant paths can lead, for example, to a gearbox region or a bearing/stock supply.

The rotor 2 has a rotor shaft 4 and a rotor stack (not shown), which is fixedly arranged on the rotor shaft 4. In all variants, the rotor shaft 4 is partially hollow with an axially extending central cavity 5. The central cavity 5 represents part of the coolant path 1 of the cooling system.

Furthermore, in all variants, the rotor shaft 4 has two radially extending transverse bores 6, which are connected to the central cavity 5 and an outer circumference of the rotor shaft 4 and which represent a further part of the coolant path 1.

The direction indication “axial” corresponds to a direction along or parallel to a central axis of rotation 10 of the rotor 2. The direction indication “radial” corresponds to a direction normal to the central axis of rotation 10 of the rotor 2.

In all variants, at least one passive valve 3 is arranged in the coolant path 1 and controls the flow rate of the coolant through the coolant path 1.

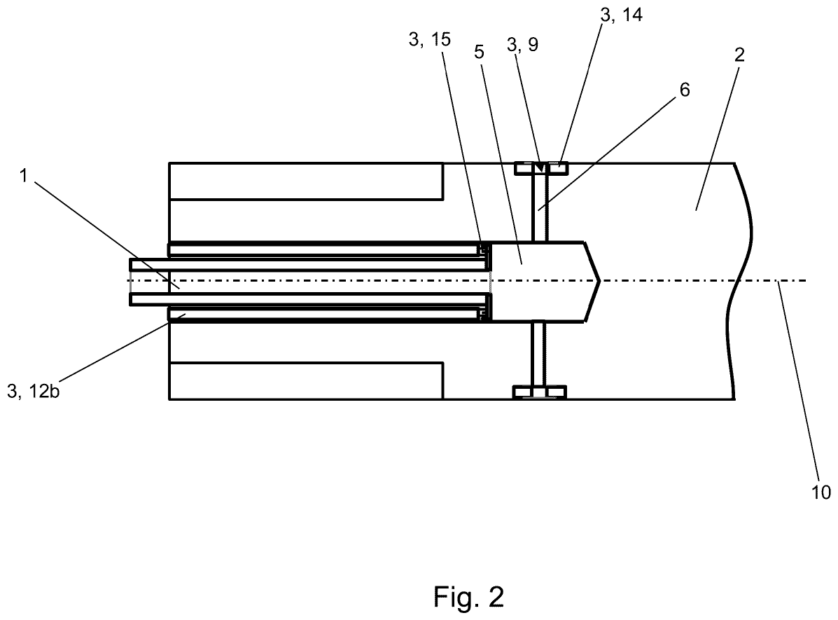

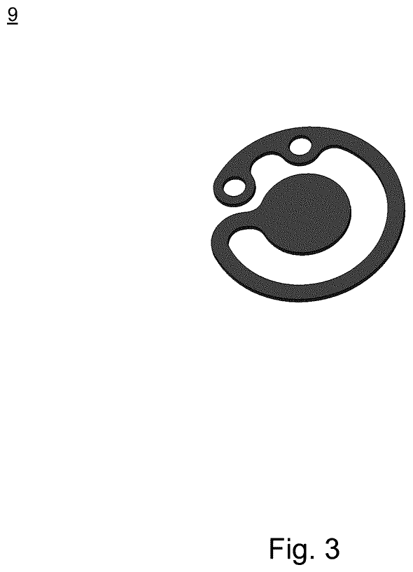

The passive valve 3 can control the flow rate of the coolant through the coolant path 1 depending on a temperature of the rotor 2 (temperature-dependent; FIG. 1, FIG. 2 and FIG. 3).

FIG. 1 shows a first variant in which the flow rate of the coolant through the coolant path 1 of the cooling system is controlled by a temperature-dependent (temperature-sensitive) passive valve 3.

The temperature-dependent passive valve 3 has an SMA element 9. In this exemplary embodiment, the SMA element 9 is designed as a platelet or plate. Furthermore, the temperature-dependent passive valve 3 has an elastic element 8c, namely a spring, and a valve sleeve 11 as well as a sleeve 12c.

In this case, the temperature-dependent passive valve 3, i.e., the SMA element 9, the elastic element 8c, the valve sleeve 11 and the sleeve 12c are arranged in this case in the region of the central cavity 5.

The SMA element 9 is connected to the rotor shaft 4 so that the heat of the rotor stack of the rotor 2 can be transferred directly into the SMA element 9. Directly adjacent to the SMA element 9 is the valve sleeve 11, which is pressed against the SMA element 9 via the elastic element 8c, namely a spring, arranged between the sleeve 12c and the valve sleeve 11. The valve sleeve 11 has two openings on its outer circumference. In an out-of-service state and at low operating temperatures, the valve sleeve 11 is held in position by the SMA element 9 and the elastic element 8c in such a way that the respective interfaces between the central cavity 5 and the transverse bores 6 are closed by the valve sleeve 11. Increasing temperatures in the rotor stack of the rotor 2 lead to a displacement of the valve sleeve 11, wherein this is pressed to the left against the force of the elastic element 8c with respect to FIG. 1 in such a way that the respective opening in the outer circumference of the valve sleeve 11 overlaps more and more axially with the respective transverse bore 6 and thus releases the interfaces between the central cavity 5 and the transverse bores 6 more and more with increasing temperature, i.e., increased cooling requirement.

FIG. 2 shows a second variant in which the flow rate of the coolant through the coolant path 1 of the cooling system is controlled via a temperature-dependent (temperature-sensitive) passive valve 3.

The temperature-dependent passive valve 3 has an SMA element 9. The SMA element 9 is ring-shaped. FIG. 3 shows a detailed representation of the SMA element 9 from FIG. 2. Furthermore, the temperature-dependent passive valve 3 has a retaining ring 14, a sleeve 12b, and a labyrinth seal 15.

In this case, the temperature-dependent passive valve 3 is arranged in the region of the central cavity 5 as well as in the region of the transverse bores 6. The SMA element 9 and the retaining ring 14 are arranged in the region of the transverse bores 6, and the sleeve 12b and the labyrinth seal 15 are arranged in the region of the central cavity 5.

Consequently, when the temperature rises in the rotor shaft 4 of the rotor 2, the SMA element 9 is also heated, resulting in an increase in the flow cross-section and thus allowing a larger coolant flow.

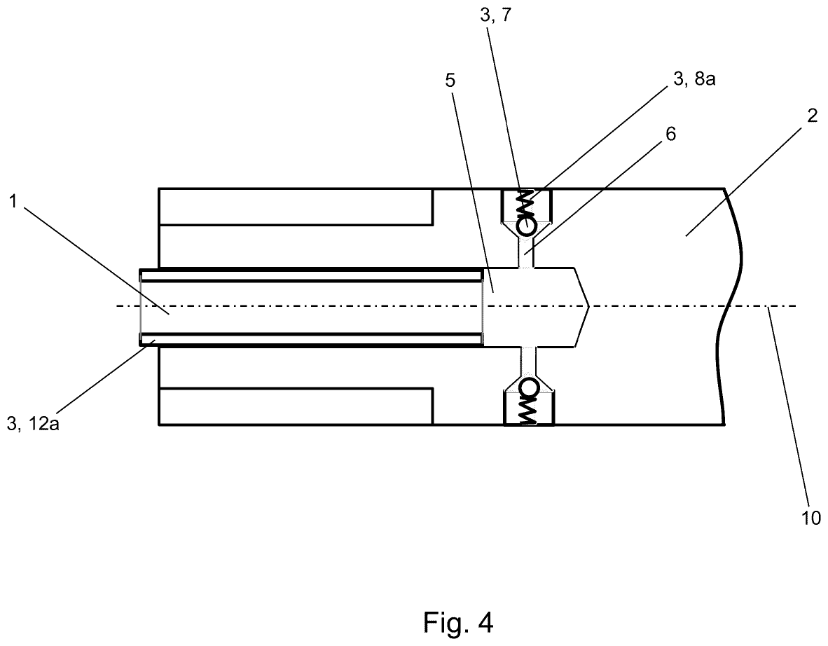

FIG. 4 shows a variant in which the flow rate of the coolant through the coolant path 1 of the cooling system is controlled by a speed-dependent passive valve 3.

The speed-dependent passive valve 3 has a sleeve 12a, a ball 7, and an elastic element 8a.

In this case, the speed-dependent passive valve 3 is arranged in the region of the central cavity 5 as well as in the region of the transverse bores 6—the ball 7 and the elastic element 8a are arranged in the region of the transverse bores 6, and the sleeve 12a is arranged in the region of the central cavity 5.

As the speed of the rotor 2 increases, the force acting on the ball 7 increases, causing the transverse bores 6 to open. The open transverse bores 6 allow coolant to flow out of or through the rotor shaft 4.

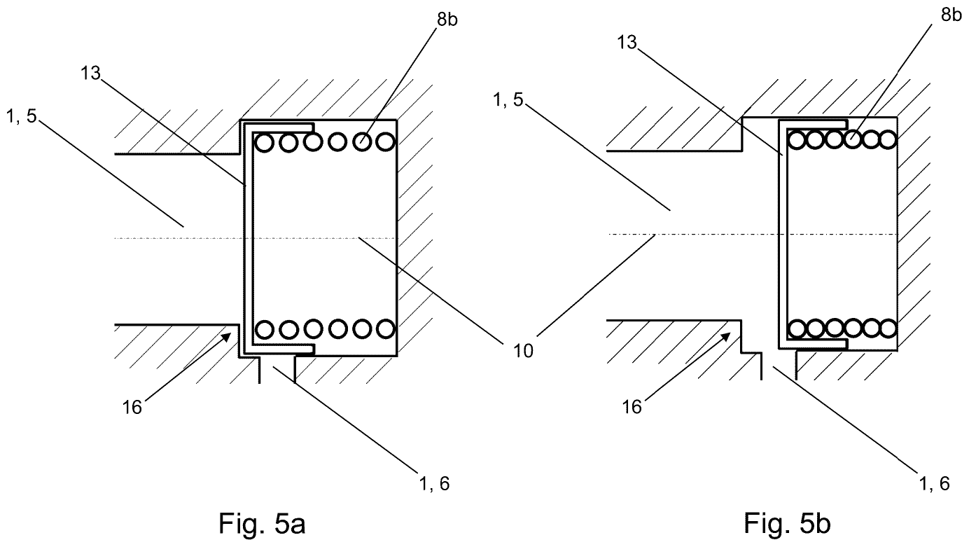

FIG. 5a and FIG. 5b show a variant in which the flow rate of the coolant through the coolant path 1 of the cooling system is controlled via a pressure-dependent passive valve 3.

In this case, the pressure-dependent passive valve 3 is arranged in the region of the central cavity 5 of the rotor shaft 4 of the rotor 2. The pressure-dependent passive valve 3 has a diaphragm 13 which is biased against the direction of flow of the coolant via an elastic element 8b against a step 16 in the central cavity 5 of the rotor shaft 4 and thus prevents the flow of coolant from the central cavity 5 to the transverse bore 6 shown (FIG. 5a).

If the pressure in coolant path 1 rises above a defined pressure, the diaphragm 13 opens against the force of the elastic element 8b and allows the coolant to flow from the central cavity 5 of the coolant path 1 to the transverse bore 6 of the coolant path 1 (FIG. 5b).

### LIST OF REFERENCE SIGNS

1 coolant path
2 rotor
3 passive valve
4 rotor shaft
5 central cavity
6 transverse bore
7 ball
8a, 8b, 8c elastic element
9 SMA element
10 central axis of rotation
11 valve sleeve
12a, 12b, 12c sleeve
13 membrane
14 retaining ring
15 labyrinth seal
16 stop

1. A cooling system for a load point dependent cooling of a rotor of an electric machine, the cooling system comprising:
at least one coolant path extending at least partially into a rotor of an electric machine,
at least one passive valve arranged in the coolant path that controls the flow rate of the coolant through the coolant path in dependence on a temperature of the rotor,
a Shape Memory Alloy (“SMA”) element provided in the rotor,
wherein a central cavity at least partially penetrating a rotor shaft of the rotor constitutes part of the coolant path, and
wherein at least one transverse bore connected to the central cavity and an outer circumference of the rotor shaft constitutes another part of the coolant path.

2. The cooling system as claimed in claim 1, wherein the passive valve is arranged in the region of the central cavity.

3. The cooling system as claimed claim 1, wherein the SMA element is connected to the rotor shaft.

4. The cooling system as claimed in claim 1, wherein the SMA element and a retaining ring are arranged in the region of the transverse bores.

5. The cooling system as claimed in claim 1, The cooling system as claimed in claim 1, wherein the passive valve is arranged in the region of the transverse bore.

6. The cooling system as claimed in claim 1, wherein the passive valve is arranged in the region of the central cavity and in the region of the transverse bore.

7. The cooling system as claimed in claim 1, wherein the SMA is designed as a platelet or plate, and is disposed in the central cavity, and the SMA expands in response to increased temperature, wherein the expansion of the SMA opens the passive valve.

8. The cooling system as claimed in claim 1, wherein the passive valve includes the SMA, a valve sleeve, an elastic element, and a sleeve, all of which are disposed in the central cavity.

9. The cooling system of claim 8, wherein the elastic element is disposed between the sleeve and the valve sleeve and biases the valve sleeve toward the SMA.

10. The cooling system of claim 9, wherein when the SMA temperature is below a threshold level, the valve sleeve blocks an interface between the central cavity and the transverse bores, and when the SMA temperature is above the threshold level, the SMA expands and shifts the valve sleeve against the bias of the elastic element such that respective openings of the valve sleeve at least partially align with the transverse bores, thereby opening the interface between the central cavity and the transverse bores.

11. The cooling system of claim 1, wherein the SMA is disposed at a radially outer end of the transverse bore.

12. The cooling system of claim 11, wherein the passive valve includes the SMA, a retaining ring that holds the SMA, a sleeve, and a labyrinth seal.

13. The cooling system of claim 12, wherein the sleeve and the labyrinth seal are disposed in the central cavity, such that the passive valve is disposed in both the central cavity and the transverse bores.

14. The cooling system of claim 11, wherein the SMA is ring shaped.

15. The cooling system of claim 14, wherein an increase in temperature of the SMA increases a flow cross-section and permits a larger coolant flow rate.

16. The cooling system of claim 1, wherein the passive valve includes the SMA, where the SMA changes shape in response to increased heating in the rotor, wherein the change in shape increases the coolant flow rate.

17. The cooling system of claim 16, wherein the SMA is disposed at a downstream end of the transverse bores.

18. The cooling system of claim 16, wherein the SMA is disposed at an upstream end of the transverse bores, and the change in shape moves a valve sleeve to increase the coolant flow rate.
